(19) United States
(12) Patent Application Publication
(10) Pub. No.: US 2022/0398774 A1
(43) Pub. Date: Dec. 15, 2022

(54) PHOTOGRAPHIC DEVICE AND AI-BASED OBJECT RECOGNITION METHOD THEREOF

(71) Applicant: ELAN MICROELECTRONICS CORPORATION, Hsin-Chu (TW)

(72) Inventors: I-Hau YEH, Hsinchu City (TW); Chia-Hsing LIN, Hsinchu City (TW); Chih-Sheng Huang, Hsinchu City (TW); Kuo-Ching HUNG, Hsinchu County (TW)

(21) Appl. No.: 17/826,497

(22) Filed: May 27, 2022

Related U.S. Application Data
(60) Provisional application No. 63/210,973, filed on Jun. 15, 2021.

(30) Foreign Application Priority Data
Mar. 28, 2022 (TW) 111111680

(51) Int. Cl. G06T 7/73

(52) U.S. Cl. CPC G06T 7/74; G06T 2207/20224; G06T 2207/30244

(57) ABSTRACT

An AI-based object recognition method is provided to recognize an object in a first image captured by a photographic device at a first shooting angle. The method includes: Step A, determining a difference value between the first shooting angle and a preset second shooting angle; Step B, converting the first image into a second image with a view angle of the second shooting angle when the difference value is greater than a preset value; and Step C, sending the second image to an artificial intelligence model for recognition.

This application claims priority of Application No. 111111680 filed in Taiwan on 28 Mar. 2022 under 35 U.S.C. § 119; and this application claims priority of U.S. Provisional Application No. 63/210,973 filed on 15 Jun. 2021 under 35 U.S.C. § 119(e); the entire contents of all of which are hereby incorporated by reference.

### BACKGROUND OF THE INVENTION

### Field of the Invention

The present invention relates to a photographic device, particularly to an artificial-intelligence-based photographic device and an object recognition method using the artificial intelligence.

### Description of the Prior Art

Nowadays, more and more photographic devices utilize artificial intelligence (AI) for image object recognition. Model training is required before utilizing AI for image object recognition. In model training, a great number of image data such as various vehicles' image data is required to generate an AI model. After model training, AI is able to perform model inference. In model inference, AI utilizes the AI model to recognize an object, e.g., recognizing different types of vehicles in an image. Generally, the image data for the model-training are with an identical shooting angle. As shown in FIG. 1, a photographic device 1 captures images at an identical shooting angle θ1 and the images are used for the model training. In practical application, however, a shooting angle of the photographic device 1 may be different from that in model training because of user's intention or unexpected factors (such as an accidental bump). Consequently, AI may fail to accurately recognize objects in the images captured by the photographic device 1. As shown in FIG. 2, the shooting angle θ2 actually used by the photographic device 1 may be different from the shooting angle θ1 used in the model training One conventional solution to the abovementioned problem is to capture images at more different shooting angles for training AI model. However, the solution is unlikely to cover all possibilities, not to mention that it would increase cost.

### SUMMARY OF THE INVENTION

One objective of the present invention is to provide a photographic device and an object recognition method thereof, which are adapted to different shooting angles.

In one embodiment, the present invention proposes an AI-based object recognition method, which is used to recognize an object in a first image captured by a photographic device at a first shooting angle. The method comprises Step A: determining a difference value between the first shooting angle and a preset second shooting angle; Step B: converting the first image into a second image with a view angle of the second shooting angle when the difference value is greater than a preset value; and Step C: sending the second image to an AI model for identification.

In one embodiment, the present invention proposes a photographic device, which comprises a lens, an optical sensor, an image processing chip, and an AI model. The optical sensor is coupled to the lens and generates a first image. The image processing chip is coupled with the optical sensor, determining a difference value between a first shooting angle that the lens uses currently and a preset second shooting angle and converting the first image into a second image with a view angle of the preset second shooting angle, while the difference value is greater than a preset value. The AI model is connected with the image processing chip and recognizes an object in the second image.

### BRIEF DESCRIPTION OF THE DRAWINGS

FIG. 1 shows a first shooting angle of a photographic device.

FIG. 2 shows a second shooting angle of a photographic device.

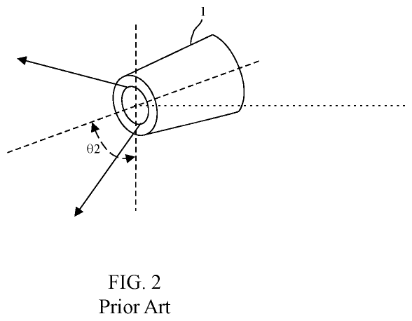

FIG. 3 shows an object recognition method for the photographic device of the present invention.

FIG. 4 shows an embodiment of determining the calibration parameter of a photographic device.

FIG. 5 shows a first embodiment of a photographic device of the present invention.

FIG. 6 is a diagram schematically showing the perspective transformation according to one embodiment of the present invention.

FIG. 7 shows a second embodiment of the photographic device of the present invention.

FIG. 8 shows a first image before calibration.

FIG. 9 shows a flowchart of an AI-based object recognition method according to one embodiment of the present invention.

### DETAILED DESCRIPTION OF THE INVENTION

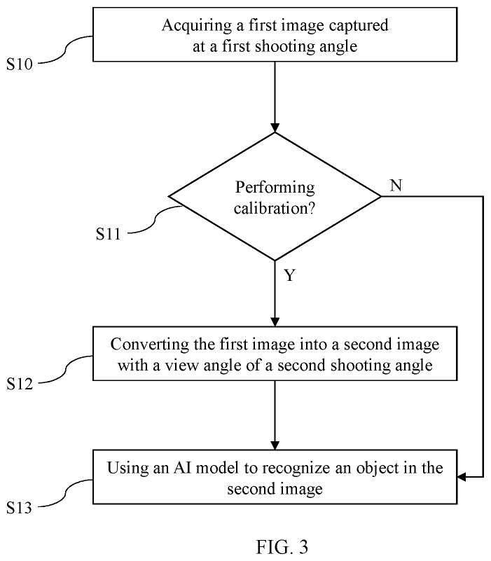

FIG. 3 is a flowchart of an AI-based object recognition method for a photographic device according to one embodiment of the present invention. In Step S10, a photographic device captures a first image at a first shooting angle. Next, in Step S11, the photographic device determines whether to calibrate the first image. If it is determined that the first image does not need calibration in Step S11, the photographic device preforms Step S13. In the Step S13, the photographic device uses an AI model to recognize an object in the first image. If it is determined that the first image needs calibration, the photographic device preforms Step S12. In the Step S12, the photographic device converts the first image into a second image with a view angle of a second shooting angle. The second shooting angle is identical to the shooting angle at which the images for training AI-model are captured. The method to convert the first image into the second image includes, but not limited to, Perspective Transformation. After the second image is generated in Step S12, the photographic device preforms Step S13 to use the AI model to recognize the object in the second image.

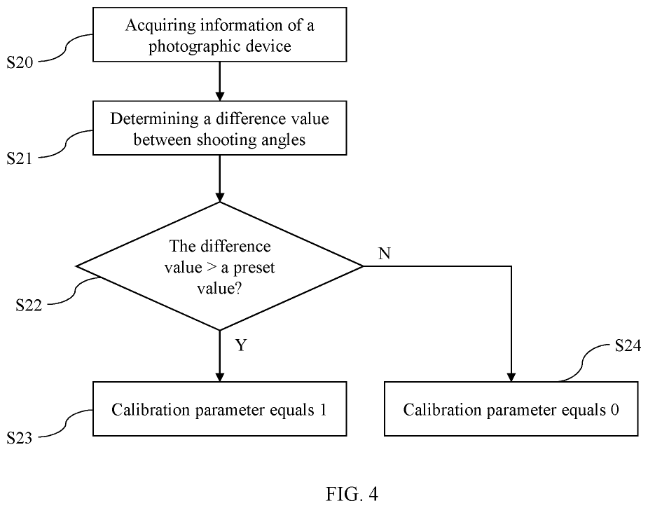

In one embodiment of Step S11, the photographic device determines whether to calibrate the first image according to a calibration parameter. For example, when the calibration parameter is “1”, it indicates that calibration is required; when the calibration parameter is “0”, it indicates that calibration is not required. An embodiment of determining the calibration parameter is shown in FIG. 4. Firstly, in Step S20, acquire the information of the photographic device. The information includes the first shooting angle which is the currently shooting angle of the photographic device. Next, in Step S21, the photographic device determines the difference value between the first shooting angle and the given second shooting angle. After the difference value is acquired, the photographic device performs Step S22 to determine whether the difference value is greater than a preset value. If the difference value is greater than the preset value, the photographic device performs Step S23. In Step S23, the calibration parameter is set to be 1, indicating the image needs calibration. If the difference value is smaller than or equal to the preset value, the photographic device performs Step S24. In Step S24, the calibration parameter is set to be “0”, indicating the image does not need calibration.

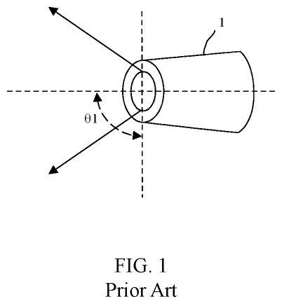

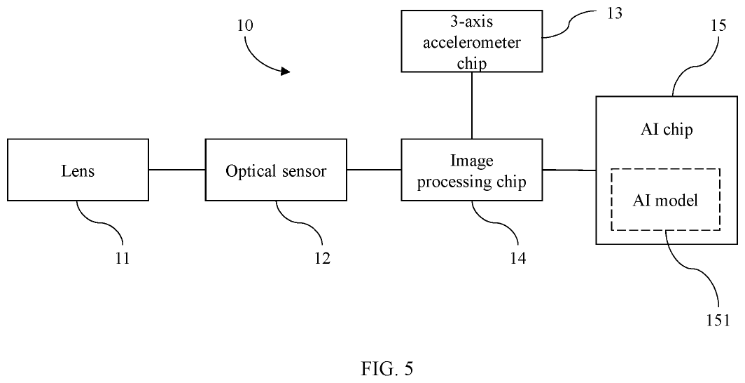

FIG. 5 shows a first embodiment of the photographic device of the present invention. In FIG. 5, the photographic device 10 includes a lens 11, an optical sensor 12, a 3-axis accelerometer chip 13, an image processing chip 14, and an AI chip 15. The optical sensor 12 is coupled to the lens 11 and configured to generate a first image. In one embodiment, the optical sensor 12 is a CMOS sensor. The 3-axis accelerometer chip 13 is coupled with the image processing chip 14 and configured to determine the first shooting angle which is the currently shooting angle of the lens 11. The image processing chip 14 is coupled with the optical sensor 12, the 3-axis accelerometer chip 13, and the AI chip 15 and configured to perform Step S12 shown in FIG. 1 and the process shown in FIG. 4. For example, when the photographic device 10 is powered on, the image processing chip 14 acquires the first shooting angle of the photographic device 10 from the 3-axis accelerometer chip 13. Next, the image processing chip 14 subtracts the stored shooting angle from the first shooting angle to acquire a difference value. In one embodiment, the second shooting angle may be stored in a memory which is outside of the image processing chip 14. After the difference value is acquired, the image processing chip 14 compares the difference value with a preset value. When the difference value is greater than the preset value, the image processing chip 14 generates a perspective transformation matrix according to the difference value and converts the first image into the second image having a view angle of the second shooting angle according to the perspective transformation matrix.

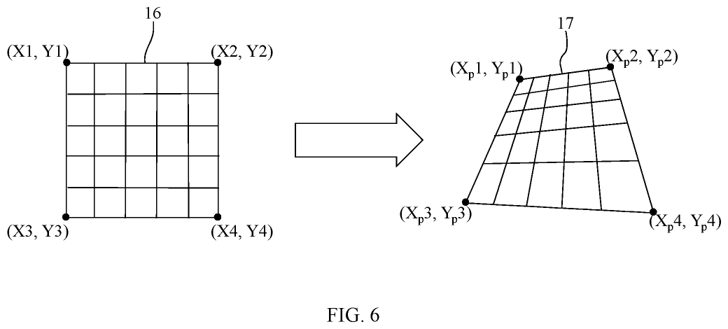

FIG. 6 is a diagram schematically showing the perspective transformation according to one embodiment of the present invention. The coordinates (X1, Y1), (X2, Y2), (X3, Y3), and (X4, Y4) of the pixels corresponding to the four corners of the first image 16 are preset values that the image processing chip 14 can acquire in advance. According to the coordinates (X1, Y1), (X2, Y2), (X3, Y3), and (X4, Y4) and the calculated difference value of shooting angle, the image processing chip 14 estimates the coordinates (Xp1, Yp1), (Xp2, Yp2), (Xp3, Yp3), and (Xp4, Yp4) of the pixels corresponding to the four corners of the second image 17. According to the coordinates (X1, Y1), (X2, Y2), (X3, Y3), (X4, Y4), (Xp1, Yp1), (Xp2, Yp2), (Xp3, Yp3), and (Xp4, Yp4), the image processing chip 14 may determine a perspective transformation matrix:

$$[ \begin{matrix}{X}^{′} \\ {Y}^{′} \\ {Z}^{′}\end{matrix} ] = [ \begin{matrix}a 11 & a 12 & a 13 \\ a 21 & a 22 & a 23 \\ a 31 & a 32 & a 33\end{matrix} ] [ \begin{matrix}X \\ Y \\ 1\end{matrix} ]$$

and then acquires:

X′=a11*X+a12*Y+a13;

Y′=a21*X+a22*Y+a23; and

Z′=a31*X+a32*Y+a33,

wherein a11-a33 are preset values. Then, the image processing chip 14 can acquire the equations for calculating the coordinates of pixels in the second image 17:

Xp=X′/Z′; and

Yp=Y′/Z′.

The AI chip 15 includes an AI model 151. The AI model 151 uses artificial intelligence to recognize objects in the second image. In one embodiment, the AI model is the MobileNet-SSD. In one embodiment, the AI chip 15 and the image processing chip 14 are integrated to be a single chip.

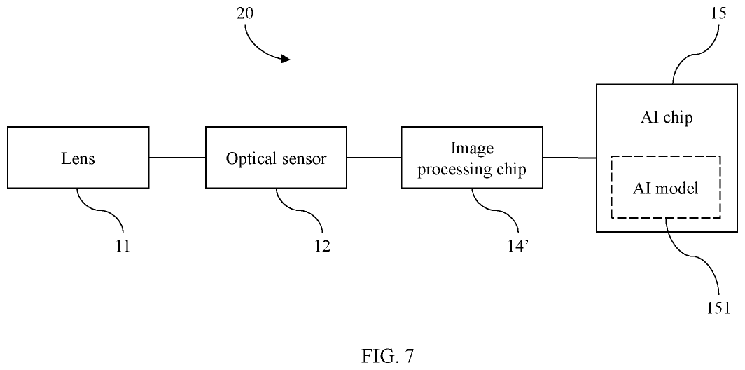

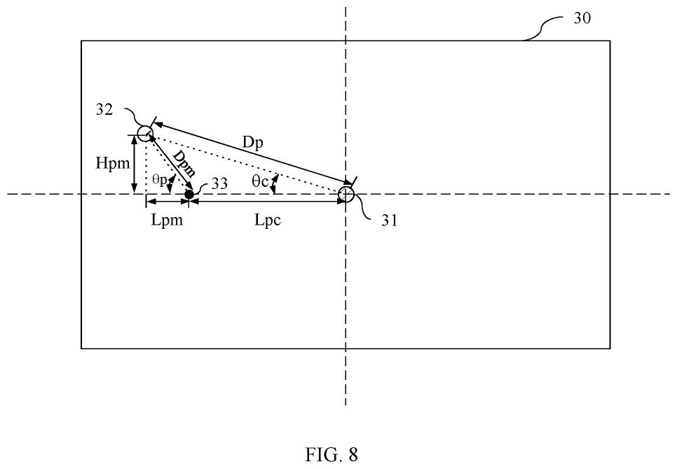

FIG. 7 shows a second embodiment of the photographic device of the present invention. The main difference between FIG. 7 and FIG. 5 is that the 3-axis accelerometer chip 13 is omitted in FIG. 7. In the second embodiment shown in FIG. 7, the difference value of the shooting angles between the first image and the second image is determined by the image processing chip 14′ based on the first image generated by the optical sensor 12. For instance, as shown in FIG. 8, the image processing chip 14′ finds a central point 31, a positioning marker 32, and a preset positioning point 33 from the first image 30. The central point 31 is the center of the first image 30. The positioning marker 32 is a marker set on the object in advance. For example, while the photographic device 20 is installed in a bus, a marker may be set on a preset position of the bus body as the positioning marker 32. The distance Lpc between the preset positioning point 33 and the central point 31 is fixed. As long as the coordinate of the central point 31 is acquired, the coordinate of the preset positioning point 33 can be determined. The preset positioning point 33 represents the position where the positioning marker 32 should appear while the photographic device 20 is at the second shooting angle. According to the positions of the central point 31, the positioning marker 32, and the preset positioning point 33, the image processing chip 14′ can calculate the difference value θc between the first shooting angle and the second shooting angle and an angle θp. The difference value θc=arcos((Lpm+Lpc)/Dp), and the angle θp=arcos(Lpm/Dpm). Lpm is the distance between the positioning marker 32 and the preset positioning point 33 in the horizontal direction. Dpm is the distance between the positioning marker 32 and the preset positioning point 33. Lpc is the distance between the preset positioning point 33 and the central point 31 in the horizontal direction. Dp is the distance between the positioning marker 32 and the central point 31. Next, the image processing chip 14′ compares the difference value θc with a preset value. When the difference value θc is greater than the preset value, the image processing chip 14′ converts the first image into the second image having a view angle of the second shooting angle. In one embodiment, the image processing chip 14′ converts the first image into the second image according to the following equations:

Xp=(X−Lpm)*((Lpm+Lpc)/Lpc)*αx+βx; and

Yp=(Y−Hpm)*((Lpm+Lpc)/Lpc)*αy+βy,

wherein X and Y are the coordinates of each pixel in the first image; Xp and Yp are the coordinates of each pixel in the second image; Hpm is the distance between the positioning marker 32 and the preset positioning point 33 in the vertical direction; values of αx, βx, αy, and βy are preset. The values of αx, βx, αy and, βy may be regulated in response to different conditions or requirements so as to fine tune the coordinates (Xp, Yp). In one embodiment, the values of αx and αy are “1”, and the values of βx and βy are “0”. In other words, the equations can be rewritten as followings:

Xp=(X−Lpm)*((Lpm+Lpc)/Lpc); and

Yp=(Y−Hpm)*((Lpm+Lpc)/Lpc).

In one embodiment, the image processing chip convert the first image into the second image with Perspective Transformation. Based on the difference value of shooting angle acquired by the abovementioned positioning point or the 3-axis accelerometer chip, the image processing chip can determine a perspective transformation matrix for converting the first image into the second image having a view angle of the second shooting angle. Whenever the photographic device is powered on, the image processing chip can generate a perspective transformation matrix based on the difference value between the first shooting angle and the second shooting angle, then, convert the first image acquired afterward into the second image having a view angle of the second shooting angle. Besides the abovementioned two methods converting the first image with a view angle of the first shooting angle into the second image with a view angle of the second shooting angle, other view-angle transformation technologies for images in the image processing field are also applicable to the present invention.

As expounded above, although the AI model of the photographic device in the present invention has not been train with the images captured at the first shooting angle, the photographic device can still accurately recognize the object in the first image captured at the first shooting angle. In other words, the photographic device in the present invention can perform AI object recognition to recognize the objects in the images captured at different shooting angles, and does not require training the photographic device with images captured at different shooting angles. Therefore, the time, image quantity, and cost for training AI model training will not increase.

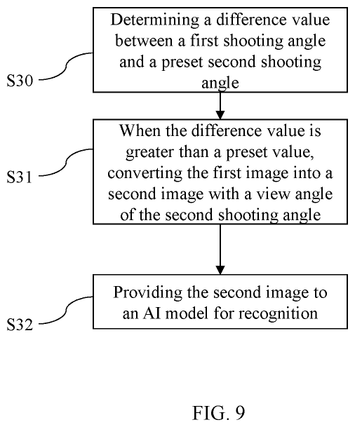

As expounded above, the AI-based object recognition method in the present invention can be demonstrated with FIG. 9 and comprises steps:

Step S30: determining the difference value between a first shooting angle and a preset second shooting angle;
Step S31: when the difference value is greater than a preset value, converting the first image into a second image with a view angle of the second shooting angle; and
Step S32: providing the second image to an AI model for recognition.

The present invention has been described with the embodiments. However, these embodiments are only to exemplify the present invention but not to limit the scope of the present invention. Any equivalent modification or variation made by the persons skilled in the art according to the technical spirit of the present invention is to be also included by the scope of the present invention.

What is claimed is:

1. An artificial-intelligence-based object recognition method, which is used to recognize an object in a first image captured by a photographic device at a first shooting angle, comprising the steps of:
Step A: determining a difference value between the first shooting angle and a second shooting angle, wherein the second shooting angle is preset;
Step B: when the difference value is greater than a preset value, converting the first image into a second image with a view angle of the second shooting angle; and
Step C: providing the second image to an artificial intelligence model for recognition.

2. The artificial-intelligence-based object recognition method according to claim 1, wherein the artificial intelligence model is trained with image data captured at the second shooting angle.

3. The artificial-intelligence-based object recognition method according to claim 1, wherein the Step A comprises:
determining the first shooting angle with a 3-axis accelerometer chip; and
subtracting the second shooting angle from the first shooting angle to acquire the difference value.

4. The artificial-intelligence-based object recognition method according to claim 1, wherein the Step A comprises:
finding a central point and a positioning marker from the first image; and
calculating the difference value based on positions of the central point, the positioning marker, and a preset positioning point.

5. The artificial-intelligence-based object recognition method according to claim 4, wherein the Step B comprises converting the first image into the second image according to equations:
Xp=(X−Lpm)*((Lpm+Lpc)/Lpc)*αx+βx; and
Yp=(Y−Hpm)*((Lpm+Lpc)/Lpc)*αy+βy, wherein
X and Y are coordinates of each pixel in the first image;
Xp and Yp are coordinates of each pixel in the second image;
Lpm is a distance between the positioning marker and the preset positioning point in the horizontal direction;
Lpc is a distance between the preset positioning point and the central point in the horizontal direction;
Hpm is a distance between the positioning marker and the preset positioning point in the vertical direction;
values of αx, βx, αy, and βy are preset.

6. The artificial-intelligence-based object recognition method according to claim 1, wherein the Step B comprises:
Step B1: generating a perspective transformation matrix according to the difference value; and
Step B2: converting the first image into the second image according to the perspective transformation matrix.

7. The artificial-intelligence-based object recognition method according to claim 1, wherein the Step B comprises:
converting the first image into the second image with perspective transformation.

8. A photographic device, comprising:
a lens;
an optical sensor, coupled to the lens and configured to generate a first image;
an image processing chip, coupled with the optical sensor, configured to determine a difference value between a first shooting angle at which the lens is currently capturing and a second shooting angle which is preset, and when the difference value is greater than a preset value, converting the first image into a second image with a view angle of the second shooting angle; and
an artificial intelligence model, coupled with the image processing chip and configured to recognize an object in the second image.

9. The photographic device according to claim 8, wherein the artificial intelligence model is trained with image data captured at the second shooting angle.

10. The photographic device according to claim 8, further comprising a 3-axis accelerometer chip coupled to the image processing chip, wherein the 3-axis accelerometer chip is configured to determine the first shooting angle and then provide the first shooting angle to the image processing chip.

11. The photographic device according to claim 10, wherein the image processing chip is configured to subtract the second shooting angle from the first shooting angle to acquire the difference value.

12. The photographic device according to claim 8, wherein the image processing chip is configured to find a central point and a positioning marker from the first image and then calculate the difference value based on positions of the central point, the positioning marker, and a preset positioning point.

13. The photographic device according to claim 12, wherein the image processing chip is configured to transform the first image into the second image according to equations:
Xp=(X−Lpm)*((Lpm+Lpc)/Lpc)*αx+βx; and
Yp=(Y−Hpm)*((Lpm+Lpc)/Lpc)*αy+βy, wherein
X and Y are coordinates of each pixel in the first image;
Xp and Yp are coordinates of each pixel in the second image; Lpm is a distance between the positioning marker and the preset positioning point in the horizontal direction;
Lpc is a distance between the preset positioning point and the central point in the horizontal direction;
Hpm is a distance between the positioning marker and the preset positioning point in the vertical direction;
values of αx, βx, αy, and βy are preset.

14. The photographic device according to claim 8, wherein the image processing chip is configured to generate a perspective transformation matrix according to the difference value and then transform the first image into the second image according to the perspective transformation matrix.

15. The photographic device according to claim 8, wherein the image processing chip is configured to transform the first image into the second image with perspective transformation.
